(19) United States
(12) Patent Application Publication
(10) Pub. No.: US 2005/0118417 A1
(43) Pub. Date: Jun. 2, 2005

(54) Optical recording medium

(76) Inventors: Kyung-Sun Min, Gyeonggi-do (KR); Myeong-Keun Ma, Gyeonggi-do (KR); Young-Jae Huh, Gyeonggi-do (KR)

Correspondence Address: CANTOR COLBURN, LLP, 55 GRIFFIN ROAD SOUTH, BLOOMFIELD, CT, 06002, US

(21) Appl. No.: 10/488,046

(22) PCT Filed: Sep. 14, 2001
(86) PCT No.: PCT/KR01/01543

(30) Foreign Application Priority Data
Aug. 27, 2001 (KR) 2001/51890

(51) Int. Cl. B32B 3/02

(52) U.S. Cl. 428/364

(57) ABSTRACT

An optical recording medium includes a disc including a dye layer and a reflecting layer formed on a substrate, a dummy substrate, and an adhesive layer adhering the disc and the dummy substrate.

### FIELD OF THE INVENTION

The present invention relates to an optical recording medium such as a digital versatile disk-recordable (DVD-R) or digital versatile disc+recordable (DVD+R) disc.

### DESCRIPTION OF RELATED ART

FIG. 1 is a cross-sectional view illustrating a conventional optical recording medium. A DVD-R/+R disc which is a “write once” format is described as an example of the optical recording medium hereinafter.

The DVD-R/+R disc 100 of FIG. 1 includes a disc 110 and a dummy disc 120. The disc 110 includes a dye layer 11, a reflecting layer 12 and a passivation layer 13 which are sequentially stacked on a poly carbonate substrate 10. The polycarbonate substrate 10 includes pregrooves (not shown) to guide a laser light during a recording operation and a reproducing operation and has a thickness of 0.6 mm. The dummy disc 120 includes a reflecting layer 16, a dye layer 17 and a passivation layer 18 which sequentially are stacked on a dummy substrate 15. At this point, the reflecting layer 16 or/and the dye layer 17 of the dummy disc 120 is/are optionally formed. The disc 110 and the dummy disc 120 are attached to each other through an adhesive layer 14.

The dye layers 11 and 17 are formed by coating an organic dye on the substrates 10 and 15, respectively, and serve as a recording layer that induces a decomposition or a transformation of a dye and a transformation of the substrates because they absorb a recording light to emit light.

The reflecting layers 12 and 16 reflect a recording light and a reproducing light to provide such an amount of light that a light detector can detect a modulation degree of a recording signal.

The passivation layers 13 and 18 prevent the reflecting layers 12 and 16 from be transformed during a recording operation, and also separates the reflecting layers 12 and 16 from the adhesive layer 14 to prevent the dye layers or the reflecting layers from be chemically damaged.

The adhesive layer 14 has an adhesive strength enough to firmly attach the two discs 110 and 120. A method for attaching the two discs 110 and 120 includes a high melting technique, a screen printing technique using a cationic UV adhesive, and a spin coating technique using a free radical UV adhesive.

When the two discs 110 and 120 are adhered through the adhesive layer 14, the following several parameters such as a moisture resistance, a heat resistance, an impact resistance, and the like should be considered.

A small amount of a monomer that is not reacted after a curing can damage the passivation layer and the reflecting layer. This can result in recording characteristics deterioration of the DVD-R/+R disc. Such a recording characteristics deterioration is accelerated by a moisture and a heat. Various methods are employed in order to protect the reflecting layer from a moisture and a heat. For example, the reflecting layer is made with a special material, or the organic dye layer is made of a stable dye.

Also, a sufficient adhesive strength should be secured for the DVD-R/+R disc 100 to endure a physical shock or impact.

Japanese laid-open publicationno. hei 10-27383 discloses an optical information medium. In order to improve an impact resistance and a moisture resistance, the optical information medium is provided with the disk forming a light interference layer and a reflection layer in at least one side surface of a planer translucent substrate and another planer disk stuck to the surface formed with the light interference layer and the reflection layer of the disk, and is constituted so that a signal is recorded by forming a pit bringing interference of light partially different from other parts to incident light and reflect light of reproducing laser light on the light interference layer by the irradiation of a recording laser light from the translucent substrate side. Margin parts without forming the light interference layer are provided on an outer peripheral side and an inner peripheral side of a signal recording area recording a signal on the disk, and the surface containing the margin parts of the side provided with the light interference layer of the disk is stuck with another disk.

Also, Japanese laid-open publication no. hei 10-106037 discloses an optical information recording medium. In order to enhance joint force with a recording layer joined to this area by surface machining an area from an outside end part to a side surface of a substrate, the optical information recording medium is a sandwich type constituted so that a disk like substrate provided with a recording layer, a reflection layer and a protection layer in this order and having a hole part on its center is stuck to a disk like protection plate with the same shape as this substrate so that the recording layer side becomes the inside respectively through an adhesive. Then, an area (a corner part that both surfaces are intersected) from the outside end part surface of the substrate having the recording layer to its side surface is chamfered, and the recording layer is joined to the area performed with the chamfering process. Further, the outside end part of the inside of the disk like substrate is preferred to be chamfered.

However, the conventional optical recording mediums necessitate the passivation layers. Since the passivation layers are cured by a UV light after coating a UV curable resin, a manufacturing process is complicated, and also the optical recording medium can be bent by a heat generated during a curing of the UV curable resin.

### SUMMARY OF THE INVENTION

To overcome the problems described above, preferred embodiments of the present invention provide an optical recording medium having a high impact resistance or high durability without any passivation layers.

It is another object of the present invention to provide an optical recording medium having a simplified manufacturing process.

It is a still another object of the present invention to provide an optical recording medium having excellent recording characteristics.

In order to achieve the above object, the preferred embodiments of the present invention provide an optical recording medium. The optical recording medium includes a disc including a dye layer and a reflecting layer formed on a substrate, and a dummy substrate. The disc and the dummy substrate are adhered to each other through an adhesive layer.

An adhesive of the adhesive layer is cured by UV-light. The adhesive layer has a viscosity of 300 cps to 900 cps at 25° C., a glass transition temperature Tg after a curing of more than 30° C., a hardness after a curing of more than “H”, and an amount of the remaining monomer after a curing of within 10%. The reflecting layer covers exposed portions of the dye layer, and the adhesive layer covers exposed portions of the reflecting layer. Adhesion enforcing regions are arranged on both an inner peripheral region and an outer peripheral region of the optical recording medium.

The optical recording medium further includes a reflecting layer formed on the dummy substrate. The reflecting layer comprises Ag, Au, Al, Cu, or their alloy. The dye layer comprises a cyanine-based dye, a hemicyanine-based dye, an azo-based dye, a triphenylmetane-based dye, or a combination of two or more thereof. The adhesive layer has a thickness of 10 μm to 80 μm.

The present invention has the following advantages. firstly, since the passivation layer is not arranged, a manufacturing process is simplified, and also excellent recording characteristics, excellent heat resistance and excellent moisture resistance can be achieved. Further, due to an adhesion enforcing region formed on both an inner peripheral region and an outer peripheral region of the disc, an adhesion strength between the two substrates is improved, leading to a high durability.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a cross-sectional view illustrating a conventional optical recording medium;

FIG. 2 is a cross-sectional view illustrating an optical recording medium according to a preferred embodiment of the present invention;

FIG. 3 is a cross-sectional view illustrating an optical recording medium according to another preferred embodiment of the present invention

FIG. 4 is a cross-sectional view an optical recording medium of Example 1 according to the preferred embodiments of the present invention; and

FIG. 5 is a cross-sectional view illustrating an optical recording medium of Comparison example 3.

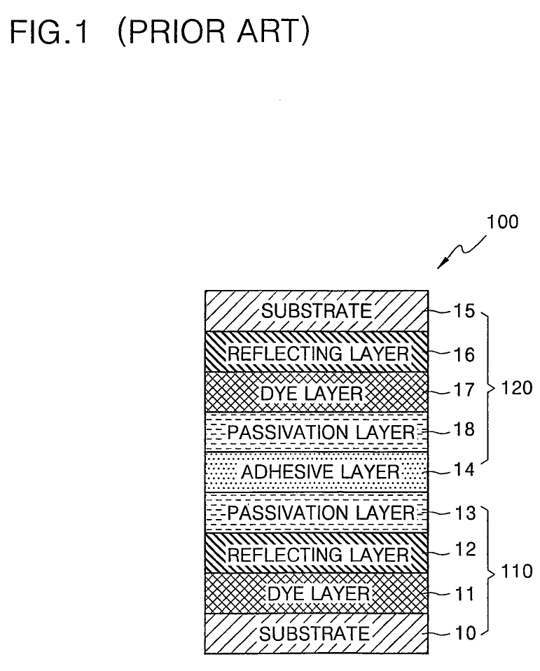

### DETAILED DESCRIPTION OF PREFFERED EMBODIMENTS

Reference will now be made in detail to preferred embodiments of the present invention, example of which is illustrated in the accompanying drawings.

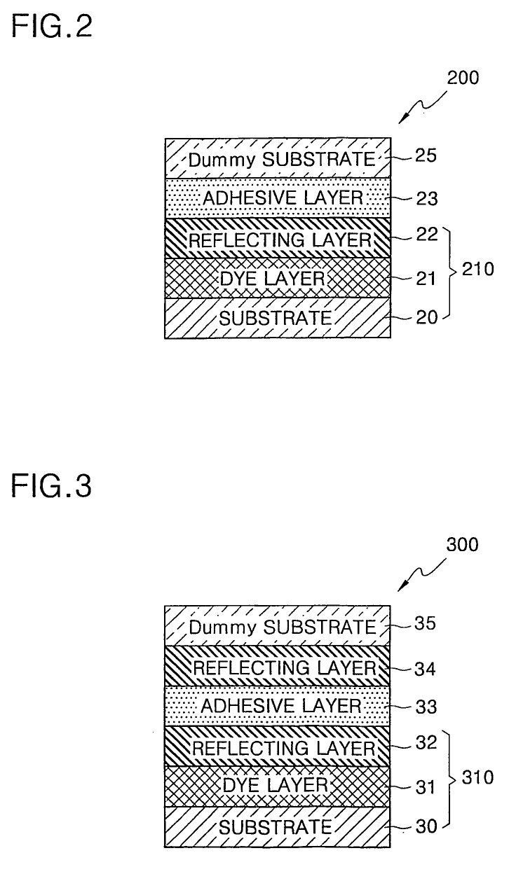

FIG. 2 is a cross-sectional view illustrating an optical recording medium according to the preferred embodiment of the present invention. A DVD-R/+R disc is described hereinafter as one example of the optical recording medium according to the preferred embodiment of the present invention.

The DVD-R/+R disc 200 of FIG. 2 includes a disc 210 and a dummy substrate 25, wherein the disc 210 includes a dye layer 21 and a reflecting layer 22 formed on a substrate 20. The disc 210 and the dummy substrate 25 are adhered to each other through an adhesive layer 23.

The substrate 20 includes pregrooves (not shown) to guide a laser light during a recording operation and a reproducing operation, and is manufactured by an injection molding using a stamper. The substrate 20 has a thickness of 0.5 mm to 0.6 mm and comprises one of polycarbonate, polymethyl methacrylate, epoxy resin, polyester, and amorphous polyolefine.

The dye layer 21 is formed by dissolving an organic dye in an organic solvent and then coating it on the substrate 20. The dye layer 21 comprises a cyanine-based dye, a hemicyanine-based dye, an azo-based dye, a triphenylmetane-based dye, or a combination of two or more thereof.

The reflecting layer 22 is formed by depositing a metal layer on the dried dye layer 21 using a sputtering technique. Preferably, the reflecting layer 22 has a thickness of 100 nm, and comprises Au, Ag, Al, Cu, or their alloy.

The disc 210 and the dummy substrate 25 are adhered by the following method: first, an adhesive is applied on a portion of the reflecting layer 22, and the dummy substrate 25 is laid on the reflecting layer 22 on which the adhesive is coated. In this state, the disc 210 and the dummy substrate 25 is spin-coated at a high rotation speed. That is, the adhesive applied on a portion of the reflecting layer 22 is spread over the entire surfaces of the reflecting layer 22 and the dummy substrate 25 by a spin coating technique. Thereafter, a UV-light is radiated to cure the adhesive, whereupon the disc 210 and the dummy substrate 25 are firmly adhered to each other. At this point, a thickness of the adhesive layer 23 depends on a temperature, a viscosity of the adhesive, and a rotation speed during a spin coating.

The adhesive layer 23 has the following features: a) viscosity of 300 cps to 900 cps at 25° C.; b) glass transition temperature Tg after a curing of more than 30° C.; c) hardness after a curing of more than “H”; and d) amount of the remaining monomer after a curing of within 10%.

The viscosity of 300 cps to 900 cps at 25° C. is to secure a sufficient thickness of the adhesive layer 23. In other words, when a viscosity of the adhesive is smaller than 300 cps, a thickness of the adhesive layer 23 is small, and therefore an adhesion strength becomes very weak. When a viscosity of the adhesive is greater than 900 cps, it is difficult to perform a spin coating.

The glass transition temperature Tg after a curing of more than 30° C. is to prevent the reflecting layer 23 from being transformed during a recording operation to improve recording characteristics of the DVD-R/+R disc and to secure a sufficient heat resistance after a recording operation. In other words, when the glass transition temperature Tg is lower than 30° C., recording characteristics and heat resistance of the DVD-R/+R disc can be lowered.

In the DVD-R/+R disc 200 of FIG. 2, an interface between the dye layer 21 and the reflecting layer 22 has a relatively weak adhesion strength. Therefore, when the adhesive layer 23 is greatly contracted during an UV-curing, an interface adhesion between the dye layer 21 and the reflecting layer 23 becomes weak, leading to bad recording characteristics. Also, due to a physical shock or impact, the dye layer 21 and the reflecting layer 22 can be separated from each other. Therefore, the adhesive should have a sufficiently low contraction coefficient not to affect an adhesion between the dye layer 21 and the reflecting layer 22 and preferably have a contraction coefficient of less than 7.0%.

The hardness after a curing of more than “H” is to improve recording characteristics during a recording operation. When the hardness is smaller than “H”, recording characteristics during a recording operation is lowered.

An amount of the remaining monomer after a curing of within 10% is to improve a chemical resistance. When an amount of the remaining monomer after a curing is more than 10%, the dye layer 21 and the reflecting layer 22 can be damaged, thereby lowering a durability. It is preferable that a thickness of the adhesive layer 23 is in a range between about 10 μm to about 80 μm. If the adhesive layer 23 has a thickness of smaller than 10 μm, an adhesion strength between the dye layer 21 and the reflecting layer 22 can be lowered. If the adhesive layer 23 has a thickness of greater than 80 μm, an interface between the dye layer 21 and the reflecting layer 22 can be damaged due to a contraction of the adhesive layer 23 during a curing.

FIG. 3 is a cross-sectional view illustrating an optical recording medium according to another preferred embodiment of the present invention. A DVD-R/+R disc is described as one example of the optical recording medium according to another preferred embodiment of the present invention.

The DVD-R/+R disc of FIG. 3 has the same structure as that of FIG. 2 except a reflecting layer 34 interposed between an adhesive layer 33 and a dummy substrate 35. In greater detail, the DVD-R/+R disc 300 includes a disc 310 and a dummy substrate 35. The disc 310 includes a dye layer 31 and a reflecting layer 32 formed on a substrate 30, and the reflecting layer 34 is formed on the dummy substrate 35. The reflecting layers 32 and 34 are adhered to each other through an adhesive layer 33. At this point, the reflecting layers 32 and 34 comprise Au, Ag, Cu, Al, or their alloy.

The optical recording medium according to the preferred embodiments of the present invention has the following advantages because the passivation layer is not arranged. Firstly, due to a simplified manufacturing process, a manufacturing yield is improved. Secondly, since a bending of the optical recording medium resulting from a UV-light radiation during a curing of the passivation layer is prevented, recording characteristics can be improved. Thirdly, a production cost is low. Fourthly, a high adhesion strength and an excellent durability can be achieved.

### EXAMPLE 1

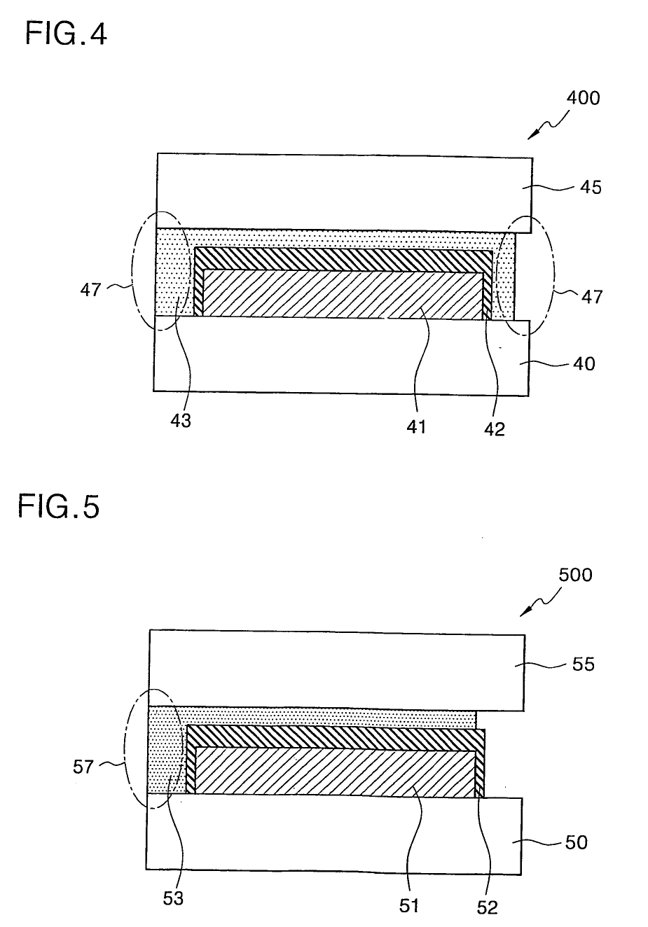

FIG. 4 is a cross-sectional view an optical recording medium of Example 1 according to the preferred embodiments of the present invention.

The optical recording medium of Example 1 is manufactured as follows: first a substrate 40 is provided. The substrate 40 includes pregrooves having a track pitch of 0.74 μm, a depth of 150 nm and a width of 350 nm. The substrate 40 comprises polycarbonate and has a thickness of 0.6 mm.

A cyanine-based organic dye NK-4499 of 0.25 g available from Japanese company “Hayashibara” is dissolved in an organic solvent “TFP” of 10 ml to obtain a dye solution. The dye solution is coated on the substrate 40 using a spin coating technique to form a dye layer 41. At this point, the spin coating is performed at a speed of 3000 rpm. The dye layer 41 is not formed on an outer edge portion of the substrate 40.

The dye layer 41 formed on the substrate 40 is dried at a temperature of 80° C. for twenty minutes. Silver (Ag) is deposited on the dye layer 41 to a thickness of about 100 nm using a sputtering technique to form a reflective layer 42. The reflecting layer 42 is formed to perfectly cover the dye layer 41.

Subsequently, an adhesive is applied on a portion of the reflecting layer 42. A dummy substrate 45 is laid on the reflecting layer 42 on which the adhesive is coated. In this state, a spin coating is performed at a rotation speed of 2000 rpm, whereby an adhesive layer 43 is formed. The adhesive layer 43 is formed to perfectly cover the reflecting layer 42.

The adhesive is Desolite 660-006 available from DSM Desotech Inc. of Elgin, Ill., and has a viscosity of 300 cps, a glass transition temperature of 32° C., a contraction coefficient of 5.4%, a hardness of H, and a thickness of about 25 μm.

Thereafter, a UV-light is radiated to cure the adhesive, whereupon the two substrates 40 and 45 are firmly adhered, whereby the optical recording medium, i.e., DVD-R/+R disc 400 is completed.

As described above, the reflecting layer 42 is formed to cover the dye layer 41, and the adhesive layer 43 is formed to cover the reflecting layer 42. In other words, an adhesion enforcing region 47 is formed on both of an inner peripheral portion and an outer peripheral portion of the optical recording medium 400. As a result, an adhesion strength between the substrate 40 and the dummy substrate 45 is increased.

In order to test the DVD-R/+R disc 400 of Example 1, the following examinations was performed.

First, a moving picture was recorded on the DVD-R/+R disc 400 of Example 1 using a DVD-R recorder (e.g., DVR-200 available from Pioneer Electronics). The moving picture recorded on the DVD-R disc 400/+R of Example 1 was reproduced by a DVD player (e.g., DVD-3030 available from LG Electronics, DVD-909 available from Samsung Electronics or DV-535K available from Pioneer Electronics). As a result, the recorded moving picture can be reproduced by all of the DVD players described above.

Also, recording characteristics of the DVD-R/+R disc 400 of Example 1 were examined using DDU-1000 available from Pulse Tec. Inc. DVD-R disc 400 of Example 1 showed a jitter of 7.8%, a reflectance of 48.0%, and an error rate of 80, and thus satisfies an international standard.

After the DVD-R/+R disc 400 of Example 1 remained in a circumstance of a temperature of 60° C. and a relative humidity of 80% during six days, the DVD-R/+R disc 400 of Example 1 showed a jitter of 8.0%, a reflectance of 48.5%, and an error rate of 90. That is, the DVD-R/+R disc 400 of Example 1 showed an excellent heat resistance and an excellent humidity resistance.

Further, ten DVD-R/+R discs of Example 1 were dropped from a height of 1.5 m and then examined. All of ten DVD-R/+R discs were not broken and thus showed an excellent impact resistance.

### EXAMPLE 2

An optical recording medium of Example 2 is manufactured identically to Example 1 except the following: the adhesive layer 43 is made of MK-1010 made by the inventor of the present invention wherein MK-1010 has a viscosity of 650 cps, a glass transition temperature of 125° C., a contraction coefficient of 6.3%, and a hardness of H. Also, the adhesive layer has a thickness of 40 μm, and the reflecting layer is made of an Ag—Cu—Au alloy.

The optical recording medium of Example 2 showed recording characteristics of a jitter of 7.8%, a reflectance of 48.5%, and an error rate of 50.

After the optical recording medium of Example 2 remained in a circumstance of a temperature of 60° C. and a relative humidity of 80% during six days, the optical recording medium of Example 2 showed a jitter of 7.8%, a reflectance of 49.0%, and an error rate of 60. That is, the optical recording medium of Example 2 showed an excellent heat resistance and an excellent humidity resistance.

Further, ten optical recording mediums of Example 2 were dropped from a height of 1.5 m and then examined. All of ten optical recording medium of Example 2 were not broken and thus showed an excellent impact resistance.

### COMPARISON EXAMPLE 1

An optical recording medium of Comparison example 1 is manufactured identically to Example 1 except an addition of a passivation layer. The passivation layer is formed between the reflecting layer 42 and the dummy substrate 45 such that SK-3200 available from Sony Chemical Corporation is coated on the reflecting layer 42 and then cured by a UV-light.

The optical recording medium of Comparison example 1 showed recording characteristics of a jitter of 8%, a reflectance of 48.5%, and an error rate of 100.

After the optical recording medium of Comparison example 1 remained in a circumstance of a temperature of 60° C. and a relative humidity of 80% during six days, the optical recording medium of Comparison example 1 showed a jitter of 8.5%, a reflectance of 49.0%, and an error rate of 150. That is, the optical recording medium of Comparison example 1 showed a heat resistance and a humidity resistance inferior to Example 2 having no passivation layer.

Further, ten optical recording mediums of Comparison example 1 were dropped from a height of 1.5 m and then examined. All of ten optical recording mediums of Comparison example 1 were not broken and showed an excellent impact resistance.

### COMPARISON EXAMPLE 2

An optical recording medium of Comparison example 2 is manufactured identically to Example 2 except the adhesive layer and the passivation layer. The adhesive layer is formed using SK-6000 available from Sony Chemical Corporation having a viscosity of 300 cps, a glass transition temperature of 89° C., a contraction coefficient 8.3%, and a hardness of H. The passivation is formed between the reflecting layer 42 and the dummy substrate 45 such that SK-3200 is coated on the reflecting layer and then cured by a UV-light.

The optical recording medium of Comparison example 2 showed recording characteristics of a jitter of 8.4%, a reflectance of 48.5%, and an error rate of 120. That is, recording characteristics are lowered.

After the optical recording medium of Comparison example 2 remained in a circumstance of a temperature of 60° C. and a relative humidity of 80% during six days, the optical recording medium of Comparison example 2 showed a jitter of 10.0%, a reflectance of 53.0%, and an error rate of 500. That is, the optical recording medium of Comparison example 2 showed a heat resistance and a humidity resistance inferior to Example 2 having no passivation layer.

Further, ten optical recording mediums of Comparison example 2 were dropped from a height of 1.5 m and then examined. Among ten optical recording mediums of Comparison example 2, the two were broken. This indirectly shows that an adhesion strength between the dye layer 41 and the reflecting layer 42 is significantly lowered due to a great contraction generated during a UV-light curing.

### COMPARISON EXAMPLE 3

FIG. 5 is a cross-sectional view illustrating an optical recording medium of Comparison example 3. The optical recording medium 500 is manufactured identically to Example 2 except that an adhesion enforcing region 57 is formed only on an outer peripheral region of the optical recording medium 500.

The optical recording medium of Comparison example 3 showed recording characteristics of a jitter of 7.5%, a reflectance of 48.5%, and an error rate of 50.

After the optical recording medium of Comparison example 3 remained in a circumstance of a temperature of 60° C. and a relative humidity of 80% during six days, the optical recording medium of Comparison example 3 showed a jitter of 10.8%, a reflectance of 52.0%, and an error rate of 600. That is, the optical recording medium of Comparison example 3 showed a heat resistance and a humidity resistance inferior to Example 2.

Further, ten optical recording mediums of Comparison example 3 were dropped from a height of 1.5 m and then examined. Among ten optical recording mediums of Comparison example 3, the four were broken. This indirectly shows that the adhesion enforcing region 57 should be formed on both an inner peripheral portion and an outer peripheral portion of the optical recording medium.

### COMPARISON EXAMPLE 4

An optical recording medium of Comparison example 4 is manufactured identically to Example 2 except that the adhesive layer is made of Desolite 650-002 having a viscosity of 10 cps, a glass transition temperature of 26° C. and a contraction coefficient of 7.0%, and has a thickness of 8 μm.

The optical recording medium of Comparison example 4 showed recording characteristics of a jitter of 8.8%, a reflectance of 48.5% and an error rate of 200. That is, recording characteristics of the optical recording medium of Comparison example 4 is lower than Example 2. When ten discs were dropped from a height of 1.5 m, seven discs were broken. That is, since a thickness of the adhesive layer is relatively thin, i.e., lower than 10 μm, an adhesion strength of the adhesive layer is lowered.

As described hereinbefore, since the passivation layer is not arranged, a manufacturing process is simplified, and also excellent recording characteristics, excellent heat resistance and excellent moisture resistance can be achieved. Further, due to an adhesion enforcing region formed on both an inner peripheral region and an outer peripheral region of the disc, an adhesion strength between the two substrates is improved, leading to a high durability.

While the invention has been particularly shown and described with reference to preferred embodiments thereof, it will be understood by those skilled in the art that the foregoing and other changes in form and details may be made therein without departing from the spirit and scope of the invention.

1. An optical recording medium, comprising:
a disc including a dye layer and a reflecting layer formed on a substrate;
a dummy substrate; and
an adhesive layer adhering the disc and the dummy substrate.

2. The medium of claim 1, wherein an adhesive of the adhesive layer is cured by UV-light.

3. The medium of claim 1, wherein the adhesive layer has a viscosity of 300 cps to 900 cps at 25° C., a glass transition temperature Tg after a curing of more than 30° C., a hardness after a curing of more than “H”, and an amount of the remaining monomer after a curing of within 10%.

4. The medium of claim 1, wherein the reflecting layer covers exposed portions of the dye layer, and the adhesive layer covers exposed portions of the reflecting layer.

5. The medium of claim 1, wherein adhesion enforcing regions are arranged on both an inner peripheral region and an outer peripheral region of the optical recording medium.

6. The medium of claim 1, further comprising, a reflecting layer formed on the dummy substrate.

7. The medium of claim 1, wherein the reflecting layer comprises Ag, Au, Al, Cu, or their alloy.

8. The medium of claim 1, wherein the dye layer comprises a cyanine-based dye, a hemicyanine-based dye, an azo-based dye, a triphenylmetane-based dye, or a combination of two or more thereof.

9. The medium of claim 1, wherein the adhesive layer has a thickness of 10 μm to 80 μm.
